(19) United States
(12) Patent Application Publication
(10) Pub. No.: US 2009/0290752 A1
(43) Pub. Date: Nov. 26, 2009

(54) Method for producing video signatures and identifying video clips

(76) Inventor: Hari Kalva, Delray Beach, FL (US)

Correspondence Address: MARTIN NOVACK, 16355 VINTAGE OAKS LANE, DELRAY BEACH, FL, 33484, US

(21) Appl. No.: 12/454,559

(22) Filed: May 19, 2009

Related U.S. Application Data
(60) Provisional application No. 61/128,089, filed on May 19, 2008.
(60) Provisional application No. 61/206,067, filed on Jan. 27, 2009.

(51) Int. Cl. G06K 9/00

(52) U.S. Cl. 382/100; 382/131

(57) ABSTRACT

A method for receiving input video having a sequence of input video frames, and producing a compact video signature as an identifier of the input video, includes the following steps: generating a processed video tomograph using an arrangement of corresponding lines of pixels from the respective frames of the sequence of video frames; measuring characteristics of the processed video tomograph; and producing the video signature from the measured characteristics.

### PRIORITY CLAIM

Priority is claimed from U.S. Provisional Patent Application No. 61/128,089 filed May 19, 2008, and from U.S. Provisional Patent Application No. 61/206,067 filed Jan. 27, 2009, and both of said Provisional Patent Applications are incorporated herein by reference.

### FIELD OF THE INVENTION

This invention relates to efficient identification of video clips and, more particularly, to a method for generating compact video signatures, and using the video signatures for identifying video clips.

### BACKGROUND OF THE INVENTION

Video copy detection, also referred to as video identification, is an important problem that impacts applications such as online content distribution. A major aspect thereof is determining whether a given video clip belongs to a known set of videos. One scenario is movie studios interested in monitoring whether any of their video is used without authorization. Another common application is determining whether copyrighted videos are uploaded to video sharing websites. A related problem is determining the number of instances a clip appears in a given source/database. For example, advertisers would be able to monitor how many times an advertisement is shown. These problems are challenging and the solutions have been considered to fall into two classes 1) digital watermark based video identification, and 2) content based video identification. Digital watermarking based solutions assume an embedded watermark that can be extracted anytime in order to determine the video source. Digital watermarking for video and images has been proposed as a solution for identification and tamper detection in video and images (see, for example, G. Doerr and J.-L. Dugelay, “A Guide Tour of Video Watermarking,” Signal Processing: Image Communication, Volume 18, Issue 4, April 2003, Pages 263-282). While digital watermarking can be useful in identifying video sources, they are not usually designed to address the problem of identifying unique clips from the same video source. Even if frame-unique watermarks are embedded, the biggest obstacle of using watermarking is the embedding of a robust watermark in the source. Another issue is that large collections of digital assets without watermarks already exist.

The drawbacks of digital watermarking are being addressed in an emerging area of research referred to as blind detection (see, for example, T. T. Ng, S. F. Chang, C. Y. Lin, and Q. Sun, “Passive-Blind Image Forensics,” in Multimedia Security Technologies for Digital Rights, Elsevier (2006); W. Luo, Z. Qu, F. Pan, J. Huang, “A Survey of Passive Technology for Digital Image Forensics,” Frontiers of Computer Science in China, Volume 1, Issue 2, May 2007, pp. 166-179). Blind detection based approaches, like digital watermarks, address the problem of tampering detection and source identification. Unlike watermarks, blind detection uses characteristics inherent to the video and capture devices to detect tampering and identify sources. Nonlinearity of capturing sources, lighting consistency, and camera response function are some of the features used in blind detection. This is still an emerging area and some doubts persist about the robustness of blind detection (see, for example, T. Gloe, M. Kirchner, A. Winkler, and R. Böhme, “Can We Trust Digital Image Forensics?,” Proceedings of the 15th International Conference on Multimedia, Multimedia '07, pp. 78-86). Like watermarks, blind detection approaches are not intended to identify unique clips from the same video. Both digital watermarking and blind detection are more suitable for tamper detection and source identification and are generally not suitable for video copy detection or identification.

Content based copy detection has received increasing interest lately as this approach does not rely on any embedded watermarks and uses the content of the video to compute a unique signature based on various video features. A survey of content based video identification systems is presented in X. Fang, Q. Sun, and Q. Tian, “Content-Based Video Identification: A Survey,” Proceedings of the Information Technology: Research and Education, 2003. ITRE2003. pp. 50-54, and J. Law-To, L. Chen, A. Joly, I. Laptev, O. Buisson, V. Gouet-Brunet, N. Boujemaa, and F. Stentiford, “Video Copy Detection: A Comparative Study,” In Proceedings of the 6th ACM International Conference on Image and Video Retrieval, CIVR '07, pp. 371-378.

A content based identification system for identifying multiple instances of similar videos in a collection was presented in T. Can, and P. Duygulu, “Searching For Repeated Video Sequences,” Proceedings of the International Workshop on Multimedia information Retrieval, MIR '07, pp. 207-216. The system identifies videos captured from different angles and without any query input. Since the system is designed to identify similar videos this is not suitable for applications such as copy detection that require identification of a given clip in a data set.

A solution for copy detection in streaming videos is presented in Y. Yan, B. C. Ooi, and A. Zhou, “Continuous Content-Based Copy Detection Over Streaming Videos,” 24th IEEE International Conference on Data Engineering (ICDE) 2008. The authors use a video sequence similarity measure which is a composite of the frame fingerprints extracted for individual frames. Partial decoding of incoming video is performed and DC coefficients of key frames are used to extract and compute frame features.

A copy detection system based on the “bag-of-words” model of text retrieval is presented in C.-Y. Chiu, C.-C. Yang, and C-.S. Chen, “Efficient and Effective Video Copy Detection Based on Spatiotemporal Analysis,” Ninth IEEE International Symposium on Multimedia, 2007, pp. 202-209. This solution uses scale-invariant feature transform (SIFT) descriptors as words to create a SIFT histogram that is used in finding matches. The use of SIFT descriptors makes the system robust to transformations such as brightness variations. Each frame has a feature dimension of 1024 corresponding to the number of bins in the SIFT histogram. A clustering technique for copy detection was proposed in N. Guil, J. M. Gonzalez-Linares, J. R. Cozar, and E. L. Zapata, “A Clustering Technique for Video Copy Detection,” Pattern Recognition and Image Analysis, LNCS, Vol 4477/2007, pp. 451-458. The authors extract key frames for each cluster of the query video and perform a key frame based search for similarity regions in the target videos. Similarity regions as short as 2×2 pixels are used leading to high complexity. A content based video matching scheme using local features is presented in G. Singh, M. Puri, J. Lubin, and H. Sawhney, “Content-Based Matching of Videos Using Local Spatio-temporal Fingerprints,” Computer Vision —ACCV 2007, LNCS vol. 4844/2007, November 2007, pp. 414-423. This approach extracts key frames to match against a database and then matches the local spatio-temporal features to match videos.

Most of these content based video identification methods operate with video signatures that are computed using features extracted from individual frames. These frame based solutions tend to be complex as they require feature extraction and comparison on a frame basis. Another common feature of these approaches is the use of key frames for temporal synchronization and subsequent video identification. Determining key frames either relies on underlying compression algorithms or requires additional computation to identify key frames.

It is seen that existing content-based detection techniques can suffer from limitations including complexity and expense of computation and/or comparison. It is among the objects hereof attain improved video identification by providing robust and compact video signatures that are computationally inexpensive to compute and compare.

### SUMMARY OF THE INVENTION

In accordance with a form of the invention, a method is provided for receiving input video comprising a sequence of input video frames, and producing a compact video signature as an identifier of said input video, comprising the following steps: generating a processed video tomograph using an arrangement of corresponding lines of pixels from the respective frames of the sequence of video frames; measuring characteristics of the processed video tomograph; and producing the video signature from said measured characteristics.

In an embodiment of this form of the invention, the step of measuring characteristics of the processed video tomograph comprises measuring the occurrence of edges in the processed video tomograph, and the step of producing the video signature from said measured characteristics comprises producing counts as a function of the measured occurrence of edges.

In an embodiment of the invention, the step of generating a processed video tomograph comprises: producing a first video tomograph comprising a first frame constructed by arranging, in temporally occurring order, a first given corresponding line of pixels from each of said sequence of input video frames; producing a second video tomograph comprising a second frame constructed by arranging, in temporally occurring order, a second given corresponding line of pixels from each of said sequence of input video frames; detecting edges of said first video tomograph to obtain a first edge tomograph; detecting edges of said second video tomograph to obtain a second edge tomograph; and combining said first and second edge tomographs to obtain said processed video tomograph. In one embodiment, the first given line of pixels is a horizontal line of pixels, and the second given line of pixels is a vertical line of pixels. In another embodiment, the first given line of pixels is a diagonal line of pixels, and the second given line of pixels is an opposing diagonal line of pixels. If desired, the processed video tomography can include combinations of several edge tomographs, including horizontal, vertical, and/or diagonal, and/or other lines of pixels, including lines that are not necessarily straight lines. In a further embodiment, half-diagonals are used.

In an embodiment of the invention, the combining of said first and second edge tomographs comprises combining said edge tomographs using a Boolean logical operator, for example OR, AND, NAND, NOR, or Exclusive OR.

In accordance with another form of the invention, a method is provided for identifying an input video clip as substantially matching or not matching with respect to archived video clips, including the following steps: producing, for each video clip to be archived, an archived video signature from a processed video tomograph of said video clip; producing, for said input video clip, an input video signature from a processed video tomograph of said video clip; comparing said input video signature to at least one of said archived video signatures; and identifying the input video clip as substantially matching or not matching archived video clips depending on the results of said comparing.

In an embodiment of this form of the invention, the comparing step comprises comparing said input video signature to a multiplicity of said archived video signatures. In this embodiment, each comparison with an archived video signature results in a correlation score, and the identifying step is based on said scores.

In one embodiment of this form of the invention, the method further comprises determining shot boundaries of said input video clip, and the step of producing from said input video clip, an input video signature, comprises using frames within said shot boundaries for producing said input video signature. The determining of shot boundaries can be implemented using video tomography on said input video clip.

The techniques hereof have very low memory and computational requirements and are independent of video compression algorithms. They can be easily implemented as a part of commonly available video players.

Further features and advantages of the invention will become more readily apparent from the following detailed description when taken in conjunction with the accompanying drawings.

### BRIEF DESCRIPTION OF THE DRAWINGS

FIG. 1 is a block diagram of a network of a type in which embodiments of the invention can be employed.

FIG. 2 is a diagram illustrating how video tomographs can be constructed.

FIG. 3 includes FIG. 3(a) which shows a snapshot of soccer video sequence, FIG. 3(b) which shows a vertical tomograph image for the frame sequence, FIG. 3(c) which shows the edges in the vertical tomograph image, FIG. 3(d) which shows a horizontal tomograph image for the frame sequence, and FIG. 3(e) which shows the edges in the horizontal tomograph image.

FIG. 4 includes FIG. 4(a) which shows an example of a composite of the horizontal and vertical tomograph edges, and FIG. 4(b), which shows an example of a composite of the left and right diagonal tomograph edges.

FIG. 5 is a diagram illustrating the positions at which level changes are measured at eight equally spaced horizontal and vertical positions on the composite of tomograph edges.

FIG. 6 is a flow diagram of the signature generation process for an embodiment of the invention.

FIG. 7 is a diagram illustrating pixel pattern lines employed for producing tomographs that are used to obtain video signatures in accordance with an embodiment of the invention.

FIG. 8 is a flow diagram of a routine for determining the presence of a match of video clips using video signatures.

### DETAILED DESCRIPTION

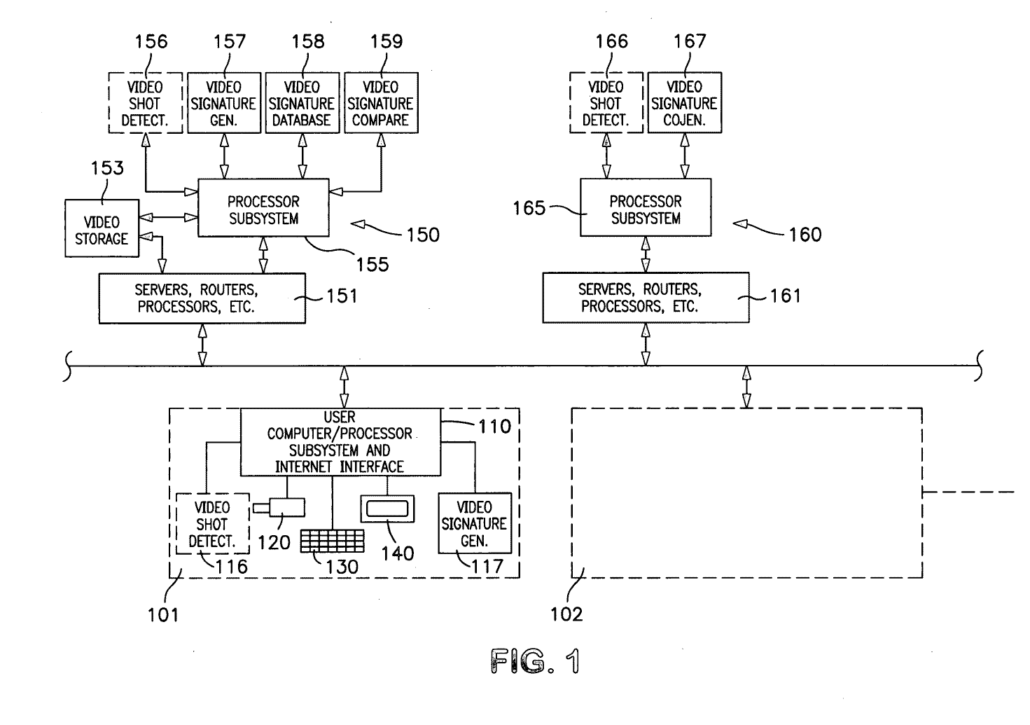

FIG. 1 is a simplified block diagram showing an internet link or network 100, a content provider station 150, a service provider station 160, and a multiplicity of user stations 101, 102, . . . . Each user station typically includes inter alia, a user computer/processor subsystem and an internet interface, collectively represented by block 110. It will be understood that conventional memory, input/output, and other peripherals will typically be included, and are not separately shown in conjunction with each processor. In the diagram of FIG. 1, each user station is shown as including a video generating capability, represented at 120, a keyboard or other text capability, represented at 130 and a display capability, represented at 140. It will be understood that the user station need not be hard wired to an internet link, with, for example, videos being received, generated, transmitted, and/or viewed from a cell phone or other hand-held device.

Also communicating with the internet link 100 of FIG. 1 is a content provider station 150, which can provide, inter alia, videos of all kinds including professional videos and video clips, and shared video clips originally generated by users. The station or site 150 includes processors, servers, and routers as represented at 151. Also shown, at the site, but which can be remote therefrom, is processor subsystem 155, which, in the present embodiment is, for example, a digital processor subsystem which, when programmed consistent with the teachings hereof, can implement embodiments of the invention. It will be understood that any suitable type of processor subsystem can be employed, and that, if desired, the processor subsystem can, for example, be shared with other functions at the website. The station 150 also includes video storage 153, and is shown as including functional blocks 156, 157, 158, and 159, the functions of which can be implemented, in whole or in part by the processor subsystem. These include video shot detection (block 156), video signature generation (block 157), video signature database (block 158) and video signature comparison (block 159). These will be described further hereinbelow. Similarly, the service provider station or website 160 includes servers, routers, processors, etc. (block 161), processor subsystem (block 165), video shot detection (block 166), and video signature detection (block 167). Again, these will be described further hereinbelow. The user stations 101, 102, . . . , are also shown as having shot detection (block 116) and video signature generating capability. If desired, the user stations can also be provided with signature comparison and signature database capabilities.

The techniques hereof utilize video tomography. Video tomography was first presented in ACM Multimedia '94 by Akutsu and Tonomura for camera work identification in movies (see A. Akutsu and Y. Tonomura, “Video Tomography: An Efficient Method For Camera Work Extraction and Motion Analysis,” Proceedings of the 2^{nd} international Conference on Multimedia, ACM Multimedia 94, 1994, pp. 349-356). Since then, this approach has been explored for summarization and camera work detection in movies (see A. Yoshitaka and Y. Deguchi, “Video Summarization Based on Film Grammar,” Proceedings of the IEEE 7th Workshop on Multimedia Signal Processing, October 2005, pp. 1-4). The video tomographs are also referred to as spatio-temporal slices (see C. W. Ngo et. al., “Video Partitioning by Temporal Slice Coherency”, IEEE Trans. CSVT, 11(8):941-953, August 2001), and the spatio-temporal slices were explored for applications in shot detection (see C. W. Ngo, Ting-Chuen Pong, HongJiang Zhang, “Motion-Based Video Representation for Scene Change Detection,” International Journal of Computer Vision 50(2): 127-142 (2002)) and segmentation (see Chong-Wah Ngo, Ting-Chuen Pong, HongJiang Zhang, “Motion Analysis and Segmentation Through Spatio-temporal Slices Processing”, IEEE Transactions on Image Processing, Vol. 12, No. 3. 341-355).

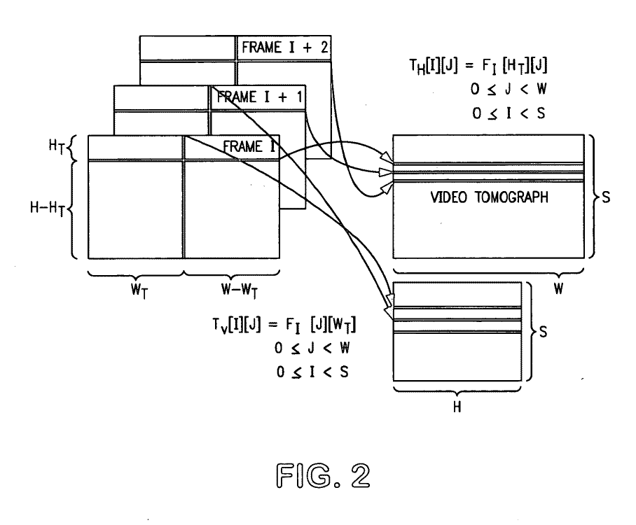

Video tomography is the process of generating tomography images for a given video shot. A tomography image is composed by taking a fixed line from each of the frames in a shot and arranging them from top to bottom to create an image. FIG. 2 illustrates the concept for a video shot of S frames. The figure shows horizontal tomography image, T_{H}, created at height H_{T} from the top-edge of the frame and a vertical tomography image, T_{V}, created at position W_{T} from the left-edge of the frame. The expressions for T_{H} and T_{V} are shown in the Figure. The height of the tomography images is equal to the number of frames in a shot. Other line patterns can be used in addition to the vertical and horizontal tomography patterns shown in FIG. 1; e.g., left and right diagonal patterns and half-diagonal patterns, and any other arbitrary patterns. Straight lines are convenient, but not required.

The image obtained using the composition process shown in FIG. 2 captures the spatio-temporal changes in the video. The position of the scan line (H_{T} or W_{T}) strongly affects the information captured in the video tomograph. When scan lines are close to the edge (e.g., H_{T}<H/5) the tomograph is likely to cut across background as most of the action in movies is at the center of the frame. Any motion in a tomograph that mainly cuts a static background would be primarily due to camera motion. On the other hand, with scan lines close to the center (e.g., H_{T}=H/2) the tomography is likely to cut across background as well as foreground objects and the information in the tomograph is a measure of spatiotemporal activity that is a combination of local and global motion. For video identification, capturing the interactions between global and local motion are critical and scan lines at the center of the frame are used.

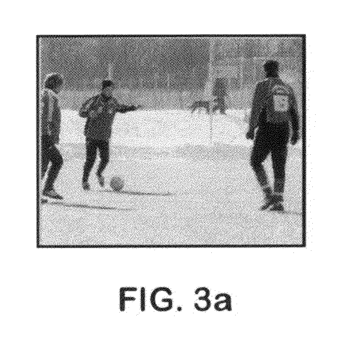

Horizontal and vertical tomography for a 300 frame shot from a Soccer video sequence is shown in FIG. 3. The tomographic images are created using only the luminance component; this has the side effect of making the system robust to color variations. FIG. 3(a) shows a snapshot of the sequence. FIG. 3(b) shows the vertical tomograph and the corresponding edge image is shown is shown in FIG. 3(c). FIG. 3(d) shows the horizontal tomograph, and the corresponding edge image is shown in FIG. 3(e). The edge images were created using the so-called Canny edge detector. The edge image clearly reveals the structure of motion in the tomograph. These edge images contain surprisingly rich information that can be used to understand the structure of the video sources. Such edge images are used to identify camera work in Akatsu et al., supra, and Yoshitaka et al., supra. These edge images are used herein for generating combined or composite edge images, which are the, in turn, used to obtain video signatures.

The Canny edge detection algorithm used for detecting edges in tomographic images is a multi-stage algorithm to detect a wide range of edges in images (see J. F. Canny, “A Computational Approach to Edge Detection”, IEEE Trans. Pattern Analysis and Machine Intelligence, vol. 8, pp. 679-698, 1986.). The algorithm smoothes the image to eliminate and noise then finds the image gradient to highlight regions with high spatial derivatives using a Gaussian filter (in this example, 3×3 pixels). After that, the algorithm tracks along these regions and suppresses any pixel that is not at the maximum (non maximum suppression). Then, using hysteresis, the gradient array is reduced. Hysteresis is used to track along the remaining pixels that have not been suppressed. Hysteresis uses two thresholds and if the magnitude is below the first threshold, it is set to zero (made a non edge). If the magnitude is above the high threshold, it is made an edge. And if the magnitude is between the two thresholds, then it is set to zero unless there is a path from this pixel to a pixel with a gradient above the second threshold. It will be understood that other edge detection techniques can be utilized.

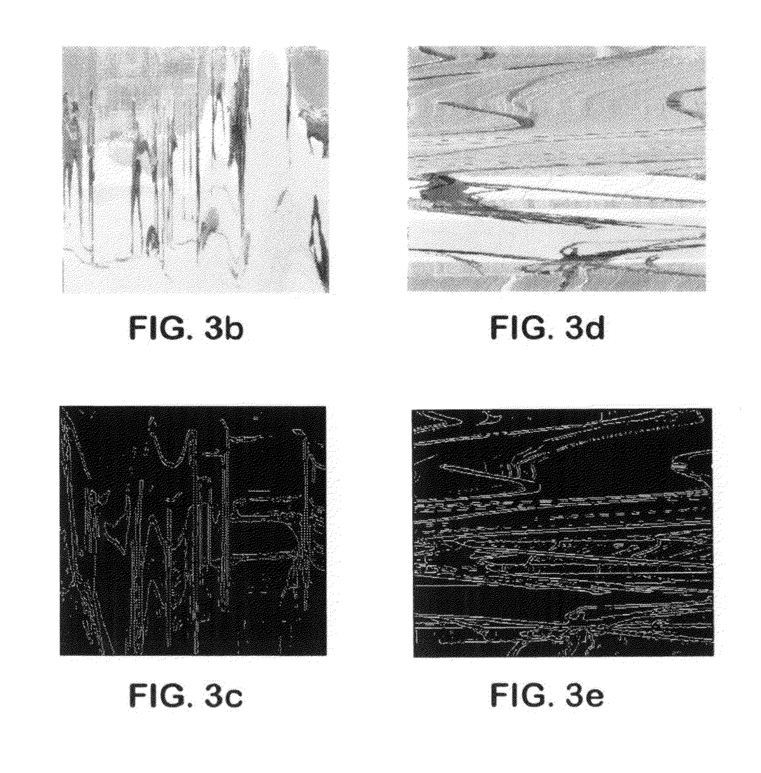

The video signatures hereof are designed to identify video clips uniquely. A clip can be a well defined shot that is S frames long or any continuous set of S frames. In one embodiment hereof, video tomographs for four scan patterns in a clip were utilized: (1) horizontal pattern at 50% (H_{T}=H/2); (2) vertical pattern at 50% (W_{T}=W/2); (3) left diagonal pattern; and (4) right diagonal pattern. The tomographic images extracted from these four patterns have a complex structure reminiscent of fingerprints as was seen in FIG. 3. Fingerprint analysis uses combination of ridge endings and ridge bifurcations to match fingerprints (see e.g. R. M. Bolle, A. W. Senior, N. K. Ratha, and S. Pankanti, “Fingerprint Minutiae: A Constructive Definition,” Lecture Notes in Computer Science, Vol. 2359/2002, pp. 58-66). In order to be able to use a fingerprint type of analysis, it is necessary to create enough artificial ridges and bifurcations from the video tomographs. Ridges and bifurcations in tomographs are formed when lines representing motion flows intersect. In embodiments hereof, this is achieved by combining tomographic images created from different scan patterns (horizontal, vertical, diagonal, etc.). In one embodiment, horizontal and vertical patterns were combined using an OR operation to create a composite image. (As previously noted, other logical operators can be used.) A second composite image was created by combining the left and right diagonal patterns. In the present embodiment, the two composite images comprise the basis for the video signatures. The composite images are visually complex, like a fingerprint. FIG. 4(a) shows an example of a composite of horizontal and vertical tomography edges (180×180), and FIG. 4(b) shows an example of a composite of left and right diagonal edges (720×180).

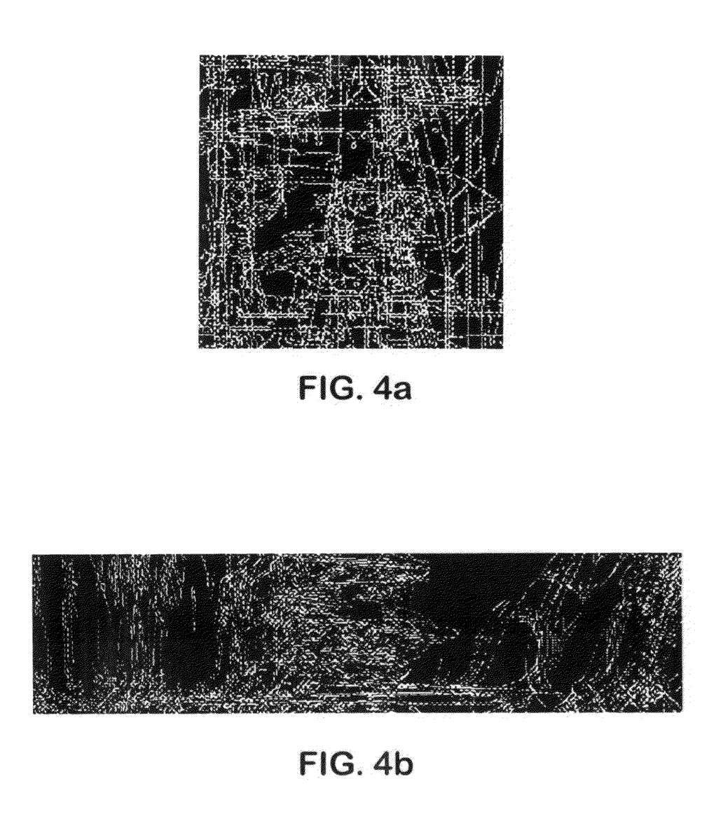

An important constraint is the ability to extract the features from the same position in the composite image irrespective of the distortion a clip may suffer due to compression and other transformations. In the present embodiment, the metric used is the number of level changes at discrete points in the composite images. The level changes are measured along horizontal and vertical lines at predetermined points in composite images. The number of such points determines the complexity and length of a signature. The number can also be taken modulo a suitable number, such as, for example, 256. FIG. 5 shows eight horizontal and vertical positions used in this embodiment. At each of these positions on a combined tomograph edge image, the number of level changes is counted; i.e, the black to white transitions representing the number of edges crossed along the line. This count can be as high as half the width of an image and is stored as a 16 bit integer. The 16 counts on the horizontal-vertical composite and the other 16 counts on the diagonal composite form a 64 byte signature for each video clip. The signature size for this example is always 64 bytes irrespective of the number of frames in a clip. Since signatures are not created for individual frames, this solution results in a compact signature and the computational cost of finding a match is very low.

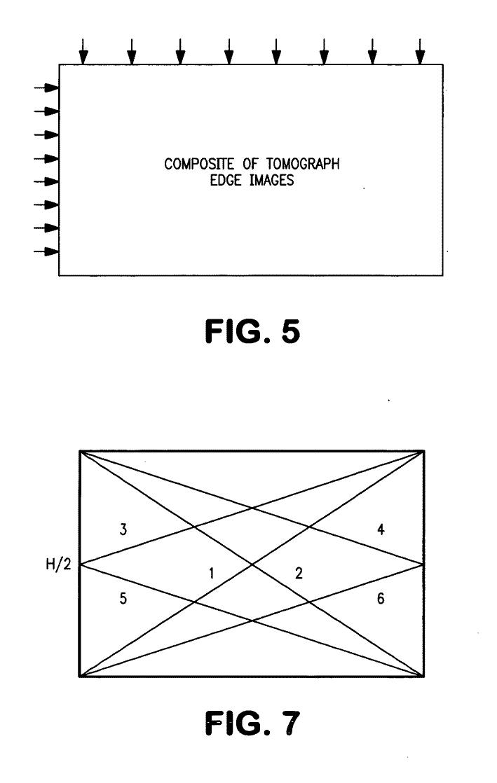

FIG. 6 is a flow diagram for controlling a processor to produce, for a sequence of frames in a video shot, a compact signature vector comprising, for example, 64 bytes, as just explained. In this example, for each frame of the video shot (605), four straight line pixel patterns are utilized; namely, a horizontal line of pixels in the middle of each frame (pattern 1—block 611), a vertical line of pixels in the middle of each frame (pattern 2—block 612), a left diagonal line of pixels (pattern 3—block 613) and a right diagonal pixel pattern (pattern 4—block 614). This results in four video tomographs. In this example, the horizontal and vertical tomographs are each edge detected (blocks 621 and 622, respectively) and then combined (block 631) using a boolean logical operator, for example an “OR” logical function, to create the combined edge tomograph (output of block 631), in the manner previously described. Similarly, the video tomographs from the two opposing diagonals are each edge detected (block 623 and 624, respectively) and then combined (block 641) using the “OR” logical function to obtain the combined edge tomograph for the diagonals (the output of block 641). Then, for each of the combined edge tomographs, the technique described in conjunction with FIG. 5 is used (blocks 651 and 652) to count changes at 8 horizontal and 8 vertical positions, so as to develop 16 vectors (each having 16 bits) for each combined edge tomograph. Thus, there are 32 vector components (16 bits each) which comprise the video signature vector (block 660). As previously indicated, this requires 64 bytes of this embodiment.

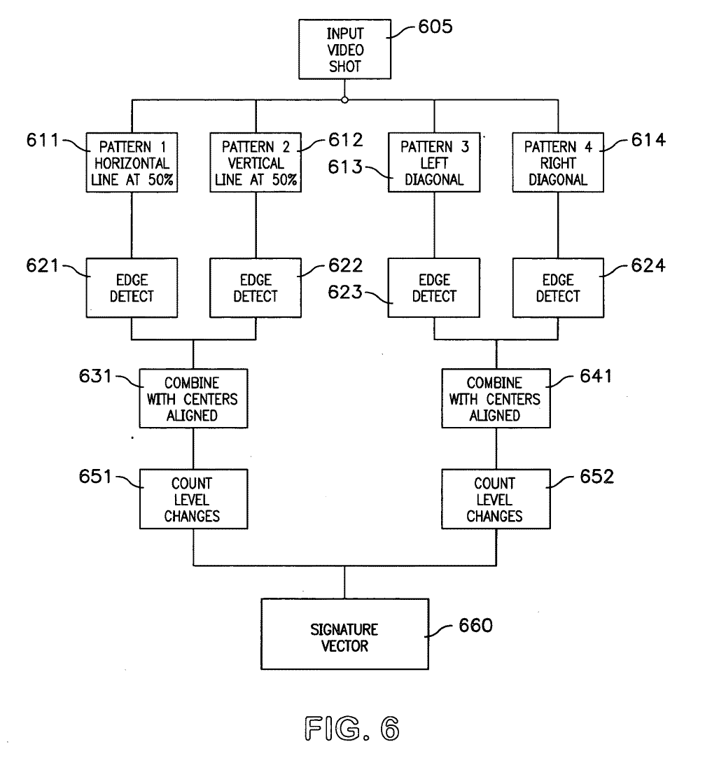

As just described, vertical, horizontal, and opposing diagonal video tomographs can be used to develop compact video signatures in accordance with an embodiment of the invention. Another embodiment of the invention uses the lines of pixels illustrated in FIG. 7 to produce six video tomographs, which are used in developing a video signature. The six lines of pixels comprise two opposing full diagonals, and two pairs of opposing half-diagonals. Since the number of samples per scan line varies with video resolution, the tomographs generated will have varying width which is a function of video resolution. In order to keep tomograph generation consistent across video resolutions, for this embodiment 360 pixels are sampled uniformly along each of the six scan lines. This results in six tomograph images each with a resolution of 360×S, where S is number of frames in the video segment for which a tomograph is being generated. Using the same type of processing as in FIG. 6, the present embodiment will instead produce 16×3=48 integers from the counts on three respective combined edge tomographs. In a form of this embodiment, 8 bits were used to represent each integer (count), by taking the counts modulo 256. Therefore, the signature vector size for this embodiment is 48 bytes.

Generating the signatures for a video clip has relatively low complexity. The complexity is dominated by the complexity of edge detection in tomographic images. For example, on a 2.4 GHz Intel Core 2 PC it takes about 65 milliseconds to generate a video signature for a 180 frame video clip. The complexity is independent of video resolution since the tomographs extracted are independent of video resolution. At 30 frames per second, the complexity of signature generation is negligible and can be implemented in a standard video player without sacrificing playback performance.

Signature comparisons can be performed using a well known correlation technique. For example, in an embodiment hereof, the Euclidean distance between the input video signature vector and each archived video signature vector (or, if appropriate, a particular archived video signature vector) is determined. For example, in the embodiment that has a 48 integer video signature vector (i.e., a 48 dimensional vector), the vector comparisons can be readily computed using the square root of the sum of the squares of the arithmetic differences. The comparison is low complexity and fast. Any suitable thresholding criteria can be established for decision making purposes.

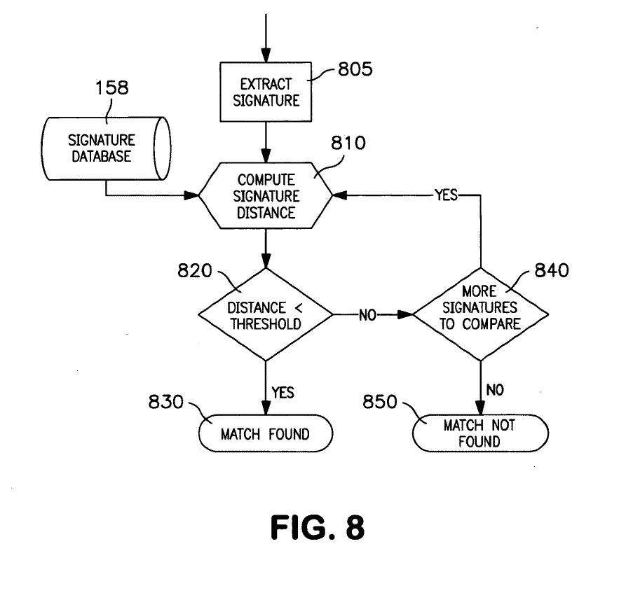

FIG. 8 is a flow diagram of the matching process. The extracted signature (block 805) is compared with a signature from signature database (158) by computing the Euclidean distance between the signatures (block 810). Determination is then made (decision block 820) regarding the thresholding criterion. If met, a match can be deemed to have been found (block 830). If not, more signatures can be considered (block 840), and after all candidates have been compared without a match being found, a no-match decision can be concluded (block 850).

Referring again to FIG. 1, consider a case where video owned by a content provider is distributed to users through one or more service providers. A content provider can create a database of signatures for shots in videos. When video is uploaded to video service providers, the service provider can extract signatures and query the content provider system for matches. Similarly, shot signatures can be generated while users are playing the video and the content provider can be contacted for a match. This system can be used to identify unauthorized use of video or to monitor the consumption of certain videos (e.g., adverts). When shot detection is used during signature generation, the same shot detection system would be advantageous at the user side for more reliable performance. If desired, it is also possible to bypass the shot detection (shown, in dashed line, as being optional) and use clips of constant length for generating signatures. It will be evident that there are many other modes of the use of video signatures hereof.

1. A method for receiving input video comprising a sequence of input video frames, and producing a compact video signature as an identifier of said input video, comprising the steps of:
generating a processed video tomograph using an arrangement of corresponding lines of pixels from the respective frames of the sequence of video frames;
measuring characteristics of the processed video tomograph; and
producing said video signature from said measured characteristics.

2. The method as defined by claim 1, wherein the arrangement of lines comprises an arrangement of lines in temporally occurring order.

3. The method as defined by claim 1, wherein said step of measuring characteristics of the processed video tomograph comprises measuring the occurrence of edges in said processed video tomograph.

4. The method as defined by claim 3, wherein said step of producing said video signature from said measured characteristics comprises producing counts as a function of said measured occurrence of edges.

5. The method as defined by claim 1, wherein said step of generating a processed video tomograph comprises:
producing a first video tomograph comprising a first frame constructed by arranging, in temporally occurring order, a first given corresponding line of pixels from each of said sequence of input video frames;
producing a second video tomograph comprising a second frame constructed by arranging, in temporally occurring order, a second given corresponding line of pixels from each of said sequence of input video frames;
detecting edges of said first video tomograph to obtain a first edge tomograph;
detecting edges of said second video tomograph to obtain a second edge tomograph; and
combining said first and second edge tomographs to obtain said processed video tomograph.

6. The method as defined by claim 5, wherein said step of producing said video signature from said measured characteristics comprises producing counts as a function of said measured occurrence of edges.

7. The method as defined by claim 6, wherein said first given line of pixels is a horizontal line of pixels, and said second given line of pixels is a vertical line of pixels.

8. The method as defined by claim 6, wherein said first given line of pixels is a diagonal line of pixels, and said second given line of pixels is an opposing diagonal line of pixels.

9. The method as defined by claim 6, wherein said first given line of pixels is a half-diagonal line of pixels, and said second given line of pixels is an opposing half-diagonal line of pixels.

10. The method as defined by claim 5, further comprising: producing a plurality of further video tomographs using further given corresponding lines of pixels from each of said sequence of input video frames; detecting edges of said further video tomographs to obtain a plurality of further edge tomographs; combining said further edge tomographs to obtain a further processed video tomograph; and measuring characteristics of said further processed video tomograph to obtain further measured characteristics; and wherein said video signature is produced from both said measured characteristics and said further measured characteristics.

11. The method as defined by claim 6, further comprising: producing a plurality of further video tomographs using further given corresponding lines of pixels from each of said sequence of input video frames; detecting edges of said further video tomographs to obtain a plurality of further edge tomographs; combining said further edge tomographs to obtain a further processed video tomograph; and measuring characteristics of said further processed video tomograph to obtain further measured characteristics; and wherein said video signature is produced from both said measured characteristics and said further measured characteristics.

12. The method as defined by claim 5, wherein said combining of said first and second edge tomographs comprises combining said edge tomographs using a Boolean logical operator.

13. The method as defined by claim 6, wherein said combining of said first and second edge tomographs comprises combining said edge tomographs using a Boolean logical operator.

14. The method as defined by claim 8, wherein said Boolean logical operator comprises an operator selected from the group consisting of OR, AND, NAND, NOR, and Exclusive OR.

15. A method for identifying an input video clip as substantially matching or not matching with respect to archived video clips, comprising the steps of:
producing, for each video clip to be archived, an archived video signature from a processed video tomograph of said video clip;
producing, for said input video clip, an input video signature from a processed video tomograph of said video clip;
comparing said input video signature to at least one of said archived video signatures; and
identifying the input video clip as substantially matching or not matching archived video clips depending on the results of said comparing.

16. The method as defined by claim 15, wherein said comparing step comprises comparing said input video signature to a multiplicity of said archived video signatures.

17. The method as defined by claim 15, wherein each comparison with an archived video signature results in a correlation score, and wherein said identifying step is based on said scores.

18. The method as defined by claim 16, wherein each comparison with an archived video signature results in a correlation score, and wherein said identifying step is based on said scores.

19. The method as defined by claim 15, further comprising determining shot boundaries of said input video clip, and wherein said step of producing from said input video clip, an input video signature, comprises using frames within said shot boundaries for producing said input video signature.

20. The method as defined by claim 19, wherein said determining of shot boundaries is implemented using video tomography on said input video clip.

21. The method as defined by claim 15, wherein said producing, for said input video clip, an input video signature from a processed video tomograph of said video clip, comprises:
producing a first video tomograph comprising a first frame constructed by arranging, in temporally occurring order, a first given corresponding line of pixels from each of a sequence of video frames of said input video clip;
producing a second video tomograph comprising a second frame constructed by arranging, in temporally occurring order, a second given corresponding line of pixels from each of said sequence of video frames of said input video clip;
detecting edges of said first video tomograph to obtain a first edge tomograph;
detecting edges of said second video tomograph to obtain a second edge tomograph;
combining said first and second edge tomographs to obtain a processed video tomograph;
measuring characteristics of the processed video tomograph; and
producing said input video signature from said measured characteristics.

22. The method as defined by claim 21, wherein said first given line of pixels is a horizontal line of pixels, and said second given line of pixels is a vertical line of pixels.

23. The method as defined by claim 21, wherein said first given line of pixels is a diagonal line of pixels, and said second given line of pixels is an opposing diagonal line of pixels.

24. The method as defined by claim 21, wherein said combining of said first and second edge tomographs comprises combining said edge tomographs using a Boolean logical operator.

25. The method as defined by claim 15, wherein said producing, for each video clip to be archived, an archived video signature from a processed video tomograph of said video clip, comprises:
producing a first video tomograph comprising a first frame constructed by arranging, in temporally occurring order, a first given corresponding line of pixels from each of a sequence of video frames of said archived video clip;
producing a second video tomograph comprising a second frame constructed by arranging, in temporally occurring order, a second given corresponding line of pixels from each of said sequence of video frames of said archived video clip;
detecting edges of said first video tomograph to obtain a first edge tomograph;
detecting edges of said second video tomograph to obtain a second edge tomograph;
combining said first and second edge tomographs to obtain a processed video tomograph;
measuring characteristics of the processed video tomograph; and
producing said archived video signature from said measured characteristics.

26. The method as defined by claim 25, wherein said first given line of pixels is a horizontal line of pixels, and said second given line of pixels is a vertical line of pixels.

27. The method as defined by claim 25, wherein said first given line of pixels is a diagonal line of pixels, and said second given line of pixels is an opposing diagonal line of pixels.

28. The method as defined by claim 25, wherein said combining of said first and second edge tomographs comprises combining said edge tomographs using a Boolean logical operator.
